(19) United States
(12) Patent Application Publication
(10) Pub. No.: US 2019/0073223 A1
(43) Pub. Date: Mar. 7, 2019

(54) HYBRID FAST PATH FILTER BRANCH PREDICTOR

(71) Applicant: QUALCOMM Incorporated, San Diego, CA (US)

(72) Inventors: Richard SENIOR, San Diego, CA (US); Raghuveer RAGHAVENDRA, San Jose, CA (US); Gurkanwal BRAR, San Diego, CA (US); Arvind GOVINDARAJ, San Francisco, CA (US)

(21) Appl. No.: 15/695,733

(22) Filed: Sep. 5, 2017

(51) Int. Cl. G06F 9/38; G06F 12/0855

(52) U.S. Cl. CPC G06F 9/3848; G06F 12/0855

(57) ABSTRACT

Systems and methods for branch prediction include detecting a subset of branch instructions which are not fixed direction branch instructions, and for this subset of branch instructions, utilizing complex branch prediction mechanisms such as a neural branch predictor. Detecting the subset of branch instructions includes using a state machine to determine the branch instructions whose outcomes change between a taken direction and a not-taken direction in separate instances of their execution. For the remaining branch instructions which are fixed direction branch instructions, the complex branch prediction techniques are avoided.

### FIELD OF DISCLOSURE

Disclosed aspects are directed to branch prediction in processing systems. More specifically, exemplary aspects are directed to hybrid branch prediction techniques for identifying and filtering out static branch instructions; and selectively applying complex branch prediction techniques for non-static branch instructions.

### BACKGROUND

Processing systems may employ instructions which cause a change in control flow, such as conditional branch instructions. The direction of a conditional branch instruction is based on how a condition evaluates, but the evaluation may only be known deep down an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, with a corresponding direction referred to as the “taken direction”; or a “not-taken” path which starts at the next sequential address after the conditional branch instruction, with a corresponding direction referred to as the “not-taken direction”.

When the condition is evaluated and the actual branch direction is determined, if the branch was mispredicted, (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include one or more state machines which may be trained with a history of evaluation of past and current branch instructions. For example, a bimodal branch predictor uses two bits per branch instruction (which may be indexed using a program counter (PC) of the branch instruction, and also using functions of the branch history as well as a global history involving other branch instruction histories) to represent four prediction states: strongly taken, weakly taken, weakly not-taken, and strongly not-taken, for the branch instruction. While such branch prediction mechanisms are relatively inexpensive and involve a smaller footprint (in terms of area, power consumption, latency, etc.), their prediction accuracies are also seen to be low.

More complex branch prediction mechanisms are emerging in the art for improving prediction accuracies. Among these, complex branch prediction mechanisms, so called neural branch predictors (e.g., Perceptron, Fast Path branch predictors, Piecewise Linear branch predictors, etc.) utilize bias weights and weight vectors derived from individual branch histories and/or global branch histories in making branch predictions. However, these complex branch prediction mechanisms may also incur added costs in terms of area, power, and latency. The energy and resources expended in utilizing the complex branch prediction mechanisms are seen to be particularly wasteful when mispredictions occur, albeit at a lower rate than the mispredictions which may result from the use of the simpler branch prediction mechanisms such as the bimodal branch predictor.

Among the branch instructions which are predicted using the known branch prediction techniques, it is recognized that some branch instructions (e.g., in conventional program codes/applications) are fixed direction branch instructions, in the sense that they always resolve in a fixed or static direction: static/always taken or always/static not-taken. Thus, the energy expenditure associated with branch prediction mechanisms, particularly the complex branch prediction mechanisms, is seen to be wasteful for such static branch prediction mechanisms since their outcomes are invariant.

However, there are no known mechanisms for efficiently recognizing which branch instructions are static branch instructions for selectively filtering these out and applying the complex branch prediction mechanisms for predicting only the branch instructions whose direction may vary and thus benefit from prediction. Thus, there is a corresponding need to improve energy consumption, efficiency, and prediction accuracy of conventional branch prediction mechanisms, e.g., by avoiding the aforementioned wasteful utilization of complex branch prediction mechanisms.

### SUMMARY

Exemplary aspects of the invention are directed to systems and method for branch prediction. In this disclosure, fixed direction branch instructions refer to branch instructions which always resolve in the same direction, always-taken or always-not-taken. A subset of branch instructions in a program code or application executed by a processor may have outcomes which vary and thus benefit from complex branch prediction mechanisms, while the remaining branch instructions may be fixed direction branch instructions, which are always-taken or always-not-taken and accordingly, deploying complex branch prediction mechanisms may be wasteful for these remaining branch instructions. Correspondingly, an exemplary branch prediction mechanism comprises detecting the subset of branch instructions which are not fixed direction branch instructions, for this subset of branch instructions, utilizing complex branch prediction mechanisms such as a neural branch predictor. Detecting the subset may involve an exemplary process of determining, e.g., by using a state machine, the branch instructions whose outcomes change between a taken direction and a not-taken direction in separate instances of their execution. For the remaining branch instructions which are fixed direction branch instructions, e.g., which are filtered out by the above process, the complex branch prediction techniques are avoided and their fixed direction obtained from the process of filtering.

For example, an exemplary aspect is directed to a method of branch prediction, wherein the method comprises detecting a subset of branch instructions executable by a processor which are not fixed direction branch instructions, wherein the fixed direction branch instructions are always-taken or always-not-taken. For the subset of branch instructions, the method comprises obtaining branch predictions from a neural branch predictor.

Another exemplary aspect is directed to an apparatus, wherein the apparatus comprises a filter configured to detect a subset of branch instructions which are executable by a processor and are not fixed direction branch instructions, wherein the fixed direction branch instructions are always-taken or always-not-taken. The apparatus further comprises a neural branch predictor configured to provide branch predictions for the subset of branch instructions.

Yet another exemplary aspect is directed to a non-transitory computer-readable storage medium comprising code, which, when executed by a computer, causes the computer to perform operations for branch prediction. The non-transitory computer-readable storage medium comprises code for detecting a subset of branch instructions which are not fixed direction branch instructions, wherein the fixed direction branch instructions are always-taken or always-not-taken, and code for obtaining branch predictions from a neural branch predictor, for the subset of branch instructions.

Another exemplary aspect is directed to an apparatus comprising means for detecting a subset of branch instructions which are not fixed direction branch instructions, wherein the fixed direction branch instructions are always-taken or always-not-taken, and means for obtaining branch predictions from a neural branch predictor, for the subset of branch instructions.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a processing system according to aspects of this disclosure.

FIG. 2 illustrates a neural branch predictor according to aspects of this disclosure.

FIG. 3 illustrates aspects of a filter and a neural branch predictor according to aspects of this disclosure.

FIG. 4 illustrates a sequence of events pertaining to an exemplary method of branch prediction according to aspects of this disclosure.

FIG. 5 depicts an exemplary computing device in which an aspect of this disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to systems and methods for branch prediction which overcome the aforementioned drawbacks of conventional branch prediction mechanisms. As previously noted, in this disclosure, fixed direction branch instructions refer to branch instructions which always resolve in the same direction, always-taken or always-not-taken. A subset of branch instructions in a program code or application executable by a processor may have outcomes which vary and thus benefit from complex branch prediction mechanisms. The remaining branch instructions may be fixed direction branch instructions, which are always-taken or always-not-taken and accordingly, deploying complex branch prediction mechanisms may be wasteful for these remaining branch instructions. Correspondingly, an exemplary branch prediction mechanism comprises detecting the subset of branch instructions which are not fixed direction branch instructions, for this subset of branch instructions, utilizing complex branch prediction mechanisms such as a neural branch predictor. Detecting the subset may involve an exemplary process of determining, e.g., by using a state machine, the branch instructions whose outcomes change between a taken direction and a not-taken direction in separate instances of their execution. For the remaining branch instructions which are fixed direction branch instructions, e.g., which are filtered out by the above process, their predicted direction may correspond to their fixed direction, obtained in the process of filtering them out. The above exemplary techniques will now be explained in further detail with reference to the figures.

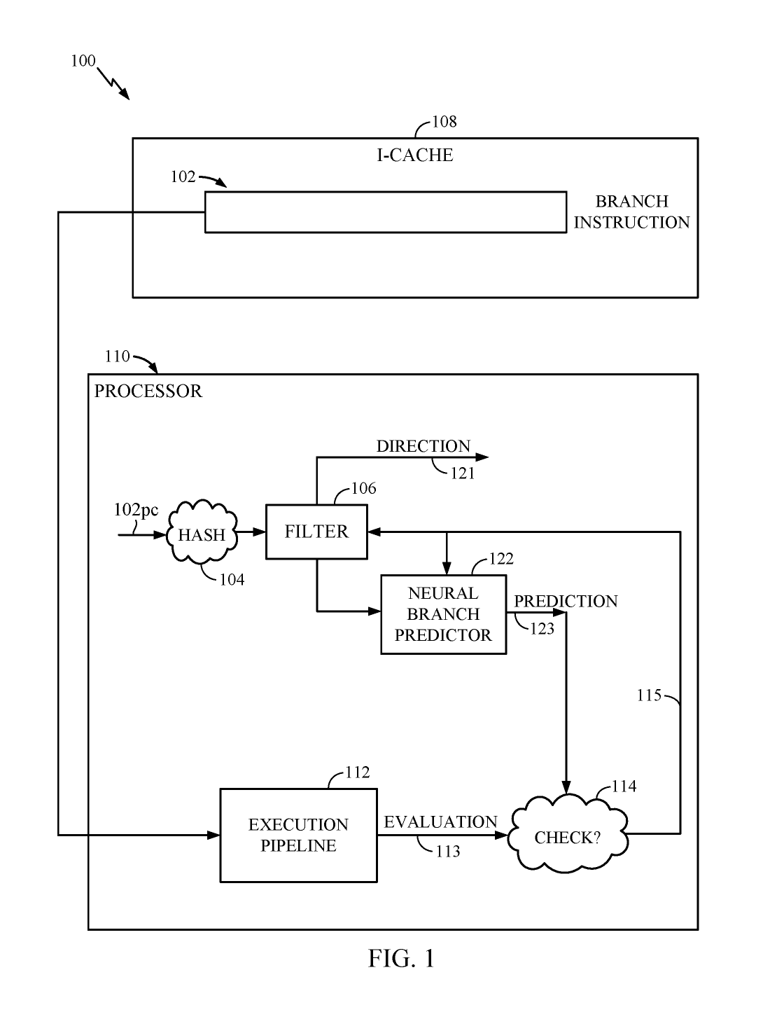

With reference now to FIG. 1, an exemplary processing system 100 in which aspects of this disclosure may be employed, is shown. Processing system 100 is shown to comprise processor 110 coupled to instruction cache 108. Although not shown in this view, additional components such as functional units, input/output units, interface structures, memory structures, etc., may also be present but have not been explicitly identified or described as they may not be germane to this disclosure. As shown, processor 110 may be configured to receive instructions from instruction cache 108 and execute the instructions using for example, execution pipeline 112. Execution pipeline 112 may be configured to include one or more pipelined stages such as instruction fetch, decode, execute, write back, etc., as known in the art. Representatively, a branch instruction is shown in instruction cache 108 and identified as branch instruction 102.

In an exemplary implementation, branch instruction 102 may have a corresponding address or program counter (PC) value of 102pc. When branch instruction 102 is fetched by processor 110 for execution, logic such as hash 104 (e.g., implementing an XOR function) may utilize the PC value 102pc (and/or other information such as a history of branch instruction 102 or global history) to access filter 106. Filter 106 may involve a state machine, as will be discussed in the following sections, and generally configured to filter out fixed direction branch instructions from a subset of branch instructions whose directions may change. For fixed direction branch instructions, the corresponding direction 121 (always-taken/always-not-taken) is obtained from filter 106.

Further, from filter 106, the subset of branch instructions which are not fixed direction branch instructions are directed to a more complex branch prediction mechanism, exemplarily shown as neural branch predictor 122 (although it will be understood that the precise implementation of the complex branch prediction mechanism is not germane to this discussion, and as such, in various examples, neural branch predictor 122 may be implemented as a Perceptron, Fast Path, Piecewise Linear predictor, etc., as known in the art). From neural branch predictor 122, prediction 123 is obtained for those branch instructions whose outcome may vary.

In exemplary aspects, for branch instructions which are filtered out as fixed direction branch instructions (e.g., by filter 106), neural branch predictor 122 may not be employed and the branch instructions may be speculatively executed in a direction corresponding to direction 121. Correspondingly, in such cases, neural branch predictor 122 may not be utilized and so neural branch predictor 122 may be bypassed, or even gated off or powered down which can lead to energy savings for the cases of fixed direction branch instructions.

Continuing with the description of FIG. 1, branch instruction 102 may be speculatively executed in execution pipeline 112 (based on a direction corresponding to either direction 121 or prediction 123). After traversing one or more pipeline states, an actual evaluation of branch instruction 102 will be known, and this is shown as evaluation 113. Evaluation 113 is compared with prediction 123 in prediction check block 114 to determine whether evaluation 113 matched prediction 123 (i.e., branch instruction 102 was correctly predicted) or mismatched prediction 123 (i.e., branch instruction 102 was mispredicted). In an example implementation, bus 115 comprises information comprising the correct evaluation 113 (taken/not-taken) as well as whether branch instruction 102 was correctly predicted or mispredicted. The information on bus 115 may be supplied to neural branch predictor 122 to update the corresponding history, weight vectors, bias values, etc., which may be utilized by neural branch predictor 122 for branch prediction. The information on bus 115 may also be supplied to filter 106 for updating the filtering process, as will be explained in further detail in the following sections.

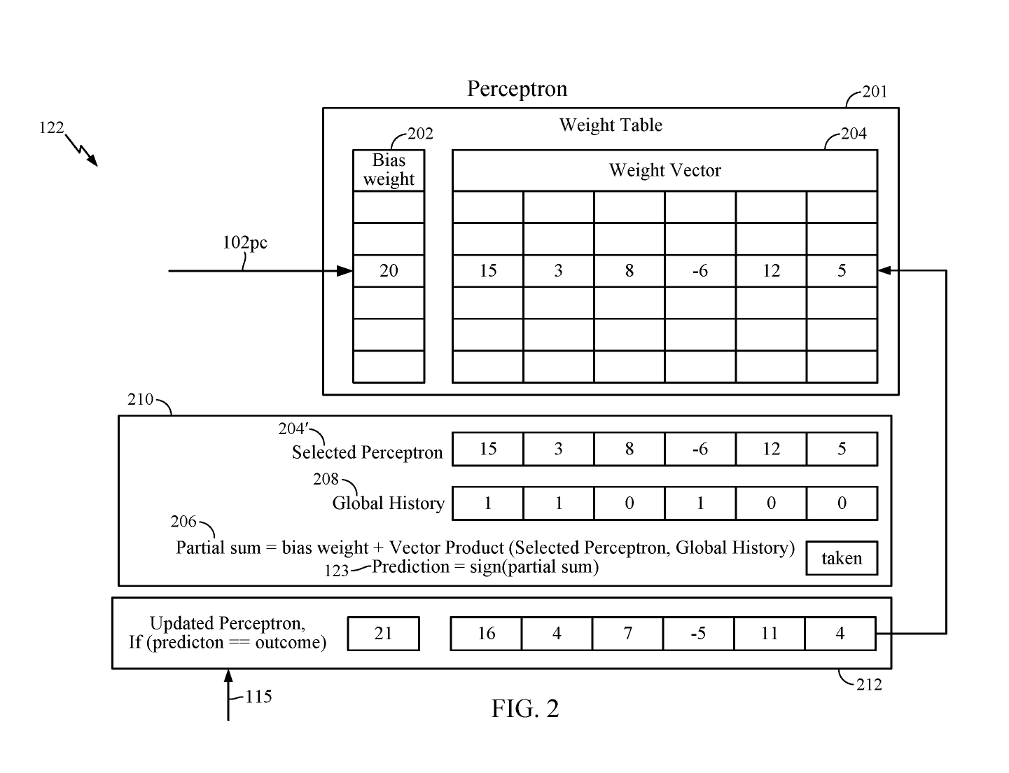

Referring now to FIG. 2 in conjunction with FIG. 1, an example implementation of neural branch predictor 122, e.g., as a Perceptron is illustrated. The Perceptron of neural branch predictor 122 includes weight table 201 comprising bias weights 202 and weight vectors 204. A specific bias weight and corresponding weight vector for branch instruction 102 (determined as not being a fixed direction branch instruction by filter 106 and directed to neural branch predictor 122 as explained above) may be indexed using the corresponding PC value, 102pc (while in some aspects, the indexing may also involve other functions, such as in the case of hash 104 discussed above).

The indexed weight vector is shown as selected perceptron 204′ in logic block 210, wherein logic block 210 is used to obtain prediction 123. Specifically, global history 208 is provided as another input to logic block 210, and using a combination of the indexed bias weight, selected perceptron 206, and global history 208, partial sum 206 for branch instruction 102 is calculated e.g., using the example formula, partial sum=bias weight+vector product (selected Perceptron, Global History). Prediction 123 is obtained in one example as corresponding to the sign of partial sum (e.g., using the example formula, prediction=sign (partial sum)) as shown. In some examples, positive and negative signs may respectively correspond to taken and not-taken predictions, without loss of generality. In the illustrated example, the sign of the partial sum is shown to correspond to a “taken” prediction (while the opposite sign may have resulted in a “not-taken” prediction). As mentioned with reference to FIG. 1, once evaluation 113 is obtained for branch instruction 102, the information on bus 115 is utilized to update the selected perceptron 206 for branch instruction 102 accordingly, which is illustrated as the block updated perceptron 212 used to update weight vector 204. The precise processes involved in generating, maintaining, and updating the bias weights 202 and weight vectors 204 of the Perceptron are beyond the scope of this disclosure, but have been briefly mentioned herein for the sake of illustration of one exemplary aspect.

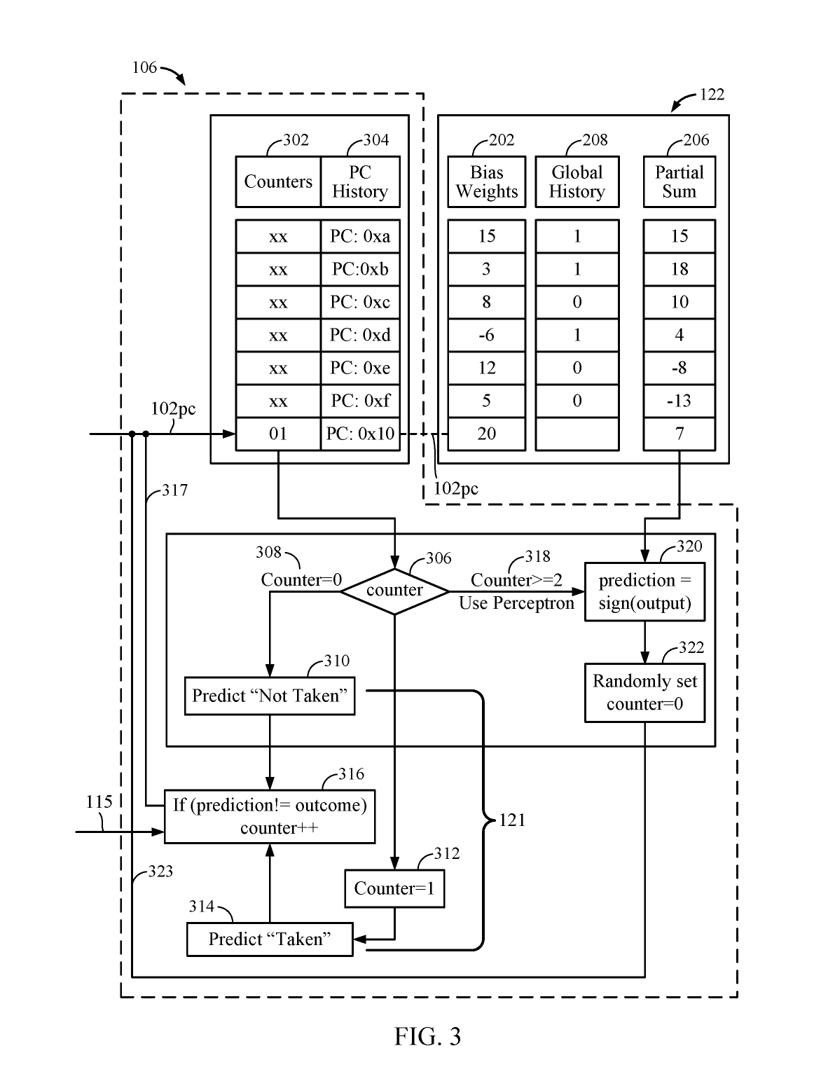

With reference now to FIG. 3, with combined reference to FIGS. 1-2, an exemplary implementation of filter 106 and its cooperation with neural branch predictor 122 will now be discussed. An exploded view of filter 106 is shown in FIG. 3 along with an abridged view of neural branch predictor 122 shown in FIG. 2. The PC value 102pc of branch instruction 102 is provided to both filter 106 and neural branch predictor 122 as previously mentioned.

Focusing on filter 106, a set of counters 302 are shown to be associated with PC values of branch instructions which may be used as a tag, identified as PC history 304. The PC value 102pc may index into one of counters 302 to obtain the value of the counter. In one implementation if there is a match between 102pc and the corresponding PC history 304 at the indexed location, then corresponding counter 302 at the indexed location may be read out. Counters 302 may be 2-bit counters and may be repurposed from conventional bimodal branch prediction mechanisms which use similar 2-bit counters as state machines to represent the previously mentioned states of strongly taken, weakly taken, weakly not-taken, and strongly not-taken, as known in the art. In filter 106, counters 302 may be utilized to represent, state machines with transitions from one state to another effected through incrementing the counters, wherein determinations of whether a particular branch instruction is a fixed direction branch instruction or not may be based on the state or counter value for a particular branch instruction.

The value of counter 302 read out from the indexed location using 102pc is used as an initial value or state associated with the counter for 102pc, which will be used in the flow chart comprising steps or blocks 306-320. For the following discussion it will be assumed that all counters 302 including the counter corresponding to branch instruction 102 are initialized to a value of “0”.

At block 306, the value of counter 302 corresponding to 102pc for branch instruction 102 is obtained. At block 308, it is determined whether the value of the counter is “0”, and if it is, then in one implementation of filter 106 at block 310, direction 121 may be generated as branch instruction 102 being a fixed direction branch instruction which is always-not-taken. Viewed another way, all branch instructions are initialized or set to an initial prediction state as always-not-taken branch instructions (keeping in mind that in other implementations, all branch instructions may be initialized to an initial state as always-taken instead, with corresponding modifications made to the remaining process steps without deviating from the scope of this disclosure). Branch instruction 102 is speculatively executed in direction 121 set to not-taken.

At block 316, the actual outcome of branch instruction 102 being speculatively executed based on the prediction of being not-taken is obtained, e.g., from bus 115 and if it is determined whether the prediction of not-taken is accurate. If the prediction is correct, then counter 302 is retained at a “0” value and the process returns to block 306. In other words, the initial prediction state of branch instruction 102 as being always-not-taken is maintained until there is a different value of counter 302 encountered in block 306.

If the prediction is not correct, i.e., branch instruction 102 was mispredicted as not-taken, then the value of counter 302 is incremented, and the incremented value (e.g., “1” in this case) is stored in counter 302 following path 317, and the process returns to block 306. Subsequently the process moves to block 312 corresponding to the value of counter 302 being “1”, which leads to direction 121 of branch instruction 102 being a fixed direction branch instruction with a direction of always-taken in block 314. In other words, upon a misprediction of the branch instruction as being a fixed direction always-not-taken branch instruction, the branch instruction is treated as a fixed direction always-taken-branch instruction. Branch instruction 102 is then speculatively executed in direction 121 set to taken.

Subsequently, the process once again returns to block 316 to determine whether the prediction of taken was correct. If the prediction was correct, then counter 302 is retained at the value of “1” to continue providing a fixed direction prediction of taken for branch instruction 102 by returning to block 306 upon each visit to block 316. If at any point in block 316, it is determined that branch instruction 102 was mispredicted as an always-taken fixed direction branch instruction, then counter 302 is further incremented, in this case, to a value of “2”, and the process updates counter 302 via path 317 and returns to block 306.

From block 306, for values of counter 302 greater than or equal to “2”, in block 318, a decision is made to use neural branch predictor 122 (e.g., Perceptron) for predictions of the branch instruction 102 going forward. Viewed another way, branch instruction 102 qualifies as a branch instruction which is among the subset of branch instructions that are predicted using neural branch predictor 122 after having been mispredicted at least once as an always-not-taken branch instruction (i.e., with counter 302 at a value of “0”) and at least once as an always-taken branch instruction (i.e., with counter 302 at a value of “1”). In yet other words, branch instruction 102 is detected or identified as belonging to a subset of branch instructions for which neural branch predictor 122 will be deployed after ensuring that branch instruction 102 is neither a fixed direction always-not-taken branch instruction nor a fixed direction always-taken branch instruction by using the above filtering process.

In block 320, prediction 123 for branch instruction 102 is obtained from the sign of corresponding partial sum 206 in block 320 (e.g., as explained with reference to FIG. 2).

Although it is possible to end the process in block 320, this may mean that each branch instruction which has qualified once as belonging to the subset of branch instructions for which neural branch predictor 122 will be used for predictions thereof will continue to have neural branch predictor 122 used in its prediction for each subsequent instance of the branch instruction. However, with time, the nature of some branch instructions may change and transition from a dynamically varying direction to a fixed direction. In order to account for these scenarios, the counters may be periodically or randomly reset to zero in block 322 and path 323 to provide the update of the reset to counters 302, which will cause the related branch instructions to once again go through the filtering process and qualify once again (if appropriate) as belonging to the subset of branch instructions for which neural branch predictor 122 will be used.

In this manner, exemplary aspects may limit the use of neural branch predictor 122 for predicting a subset of branch instructions which are not filtered out as fixed direction branch instructions. Correspondingly, wasteful power/energy consumption by neural branch predictor 122 is minimized or eliminated.

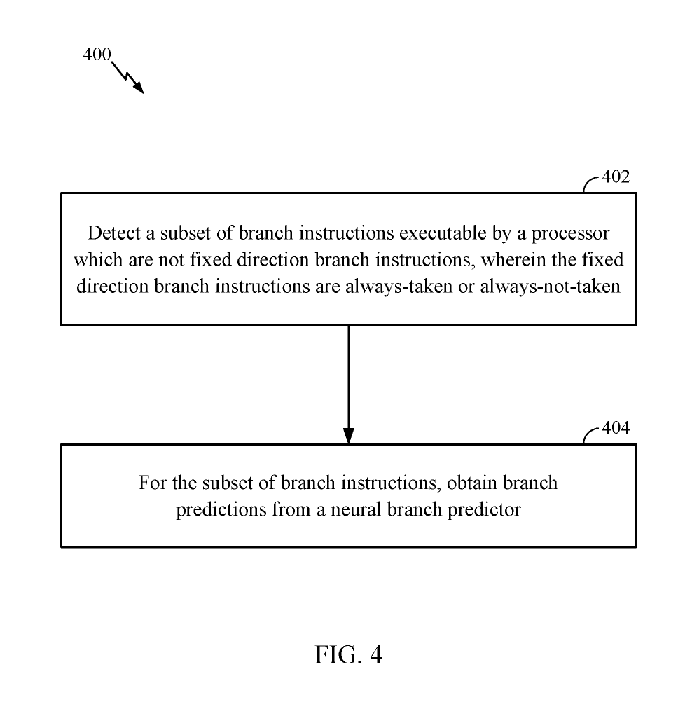

Accordingly, it will be appreciated that exemplary aspects include various methods for performing the processes, functions and/or algorithms disclosed herein. For example, FIG. 4 illustrates a method 400 of branch prediction.

Block 402 includes detecting a subset of branch instructions which are not fixed direction branch instructions, wherein the fixed branch instructions are always-taken or always-not-taken (e.g., following the steps in blocks 306-316 of filter 106 to determine, at block 308, that branch instruction 102 is not a fixed direction branch instruction).

In block 404, for the subset of branch instructions, obtaining branch predictions from a neural branch predictor (e.g., obtaining branch prediction using neural branch predictor 122 in block 320).

As discussed with reference to FIG. 3, in method 400 of FIG. 4, detecting that a branch instruction of the subset of branch instructions is not a fixed direction branch instruction comprises determining that the branch instruction has been mispredicted at least once as being not-taken (e.g., with counter 302 set to “0”) and at least once as being taken (e.g., with counter 302 set to “1”). In further detail, the above process may involve setting an initial prediction state for the branch instruction as always-not-taken (blocks 306-310), and speculatively executing the branch instruction in a not-taken direction (e.g., direction 121 from block 310). If, upon speculative execution in the not-taken direction, the branch instruction is determined to be mispredicted, the prediction state for the branch instruction is changed to always-taken (e.g., by incrementing counter 302 in block 316), and the branch instruction is speculatively executed in a taken direction (with counter 302 set to “1”). If, upon speculative execution in the taken direction, the branch instruction is determined to be mispredicted, the branch instruction is detected as belonging to the subset of branch instructions (e.g., in block 318, subsequent to the counter having been incremented to “2” in block 316). As previously mentioned, the counter may be a bimodal counter (although, various other implementations of counter 302 is possible without deviating from the scope of this disclosure). Furthermore, the counter may be randomly reset, as shown and discussed in block 322.

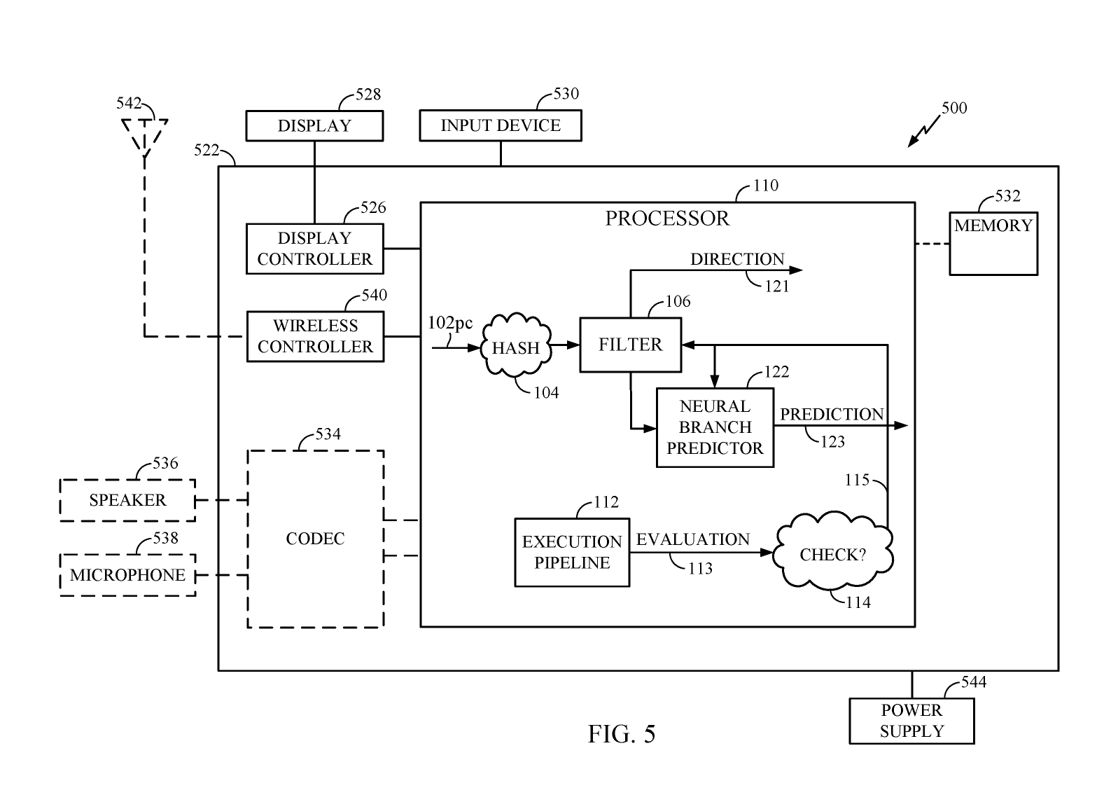

Another example apparatus, in which exemplary aspects of this disclosure may be utilized, will now be discussed in relation to FIG. 5. FIG. 5 shows a block diagram of computing device 500. Computing device 500 may correspond to an exemplary implementation of a processing system 100 of FIG. 1, wherein processor 110 may be configured to perform method 400 of FIG. 4. In the depiction of FIG. 5, computing device 500 is shown to include processor 110, with only limited details (including filter 106, neural branch predictor 122, execution pipeline 112 and prediction check block 114) reproduced from FIG. 1, for the sake of clarity. Notably, in FIG. 5, processor 110 is exemplarily shown to be coupled to memory 532 and it will be understood that other memory configurations known in the art such as instruction cache 108 have not been shown, although they may be present in computing device 500.

FIG. 5 also shows display controller 526 that is coupled to processor 110 and to display 528. In some cases, computing device 500 may be used for wireless communication, and FIG. 5 also shows optional blocks in dashed lines, such as coder/decoder (CODEC) 534 (e.g., an audio and/or voice CODEC) coupled to processor 110, and speaker 536 and microphone 538 can be coupled to CODEC 534; and wireless antenna 542 coupled to wireless controller 540 which is coupled to processor 110. Where one or more of these optional blocks are present, in a particular aspect, processor 110, display controller 526, memory 532, and wireless controller 540 are included in a system-in-package or system-on-chip device 522.

Accordingly, a particular aspect, input device 530 and power supply 544 are coupled to the system-on-chip device 522. Moreover, in a particular aspect, as illustrated in FIG. 5, where one or more optional blocks are present, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 generally depicts a computing device, processor 110 and memory 532, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for branch prediction. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of branch prediction, the method comprising:
detecting a subset of branch instructions executable by a processor which are not fixed direction branch instructions, wherein the fixed direction branch instructions are always-taken or always-not-taken; and
for the subset of branch instructions, obtaining branch predictions from a neural branch predictor.

2. The method of claim 1, wherein detecting that a branch instruction of the subset of branch instructions is not a fixed direction branch instruction comprises:
determining that the branch instruction has been mispredicted at least once as being taken and at least once as being not-taken.

3. The method of claim 2, further comprising:
initializing a prediction state for the branch instruction as always-not-taken, and speculatively executing the branch instruction in a not-taken direction;
if, upon speculative execution in the not-taken direction, the branch instruction is determined to be mispredicted, changing the prediction state for the branch instruction to always-taken, and speculatively executing the branch instruction in a taken direction; and
if, upon speculative execution in the taken direction, the branch instruction is determined to be mispredicted, detecting the branch instruction as belonging to the subset of branch instructions.

4. The method of claim 3, comprising associating a counter with the branch instruction, wherein initializing the prediction state for the branch instruction as always-not-taken comprises initializing the counter to represent a not-taken value;
if, upon speculative execution in the not-taken direction, the branch instruction is determined to be mispredicted, changing the prediction state for the branch instruction to always-taken comprises incrementing the counter to represent a taken value; and
if, upon speculative execution in the not-taken direction, the branch instruction is determined to be mispredicted, changing the prediction state for the branch instruction to always taken comprises incrementing the counter to a value which represents that the branch instruction belongs to the subset of branch instructions.

5. The method of claim 4, wherein the counter is a bimodal counter.

6. The method of claim 4, further comprising randomly resetting the counter.

7. The method of claim 4, wherein the remaining branch instructions which do not belong to the subset of branch instructions are fixed direction branch instructions whose direction is based on their associated prediction states.

8. The method of claim 1, wherein the neural branch predictor comprises one of a Perceptron, Fast Path, or Piecewise Linear branch predictor.

9. The method of claim 1, wherein obtaining branch predictions from the neural branch predictor for a branch instruction of the subset of branch instructions comprises:
indexing a weight table with a program counter (PC) value of the branch instruction to obtain a bias weight and a weight vector for the branch instruction;
determining a partial sum for the branch instruction as a function of the bias weight, the weight vector, and a global history for branch instructions; and
determining a branch prediction for the branch instruction based on a sign of the partial sum.

10. An apparatus comprising:
a filter configured to detect a subset of branch instructions which are executable by a processor and are not fixed direction branch instructions, wherein the fixed direction branch instructions are always-taken or always-not-taken; and
a neural branch predictor configured to provide branch predictions for the subset of branch instructions.

11. The apparatus of claim 10, wherein the filter is configured to detect that a branch instruction of the subset of branch instructions is not a fixed direction branch instruction, if the branch instruction has been mispredicted at least once as being taken and at least once as being not-taken.

12. The apparatus of claim 11, wherein the filter is configured to:
initialize a prediction state for the branch instruction as always-not-taken, wherein an execution pipeline is configured to speculatively execute the branch instruction in a not-taken direction;
if, upon speculative execution in the not-taken direction, the branch instruction is determined to be mispredicted in a prediction check block, change the prediction state for the branch instruction to always-taken, wherein the execution pipeline is configured to speculatively execute the branch instruction in a taken direction; and
if, upon speculative execution in the taken direction, the branch instruction is determined to be mispredicted, detect that the branch instruction belongs to the subset of branch instructions.

13. The apparatus of claim 12, wherein the filter comprises a counter associated with the branch instruction, wherein:
the counter is initialized to represent a not-taken value, to initialize the prediction state for the branch instruction as always-not-taken;
the counter is incremented to represent a taken value if, upon speculative execution in the not-taken direction, the branch instruction is determined to be mispredicted, to change the prediction state for the branch instruction to always-taken; and
the counter is incremented to a value which represents that the branch instruction belongs to the subset of branch instructions if, upon speculative execution in the not-taken direction, the branch instruction is determined to be mispredicted.

14. The apparatus of claim 13, wherein the counter is a bimodal counter.

15. The apparatus of claim 13, wherein the counter is configured to be randomly reset.

16. The apparatus of claim 13, wherein the remaining branch instructions which do not belong to the subset of branch instructions are fixed direction branch instructions whose direction is based on their associated prediction states.

17. The apparatus of claim 10, wherein the neural branch predictor comprises one of a Perceptron, Fast Path, or Piecewise Linear branch predictor.

18. The apparatus of claim 10, wherein the neural branch predictor comprises:
a weight table configured to be indexed with a program counter (PC) value of the branch instruction to provide a bias weight and a weight vector for the branch instruction;
logic configured to determine a partial sum for the branch instruction as a function of the bias weight, the weight vector, and a global history for branch instructions; and
logic configured to determine a branch prediction for the branch instruction based on a sign of the partial sum.

19. The apparatus of claim 10, integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

20. A non-transitory computer-readable storage medium comprising code, which, when executed by a computer, causes the computer to perform operations for branch prediction, the non-transitory computer-readable storage medium comprising:
code for detecting a subset of branch instructions which are not fixed direction branch instructions, wherein the fixed direction branch instructions are always-taken or always-not-taken; and
code for obtaining branch predictions from a neural branch predictor, for the subset of branch instructions.

21. The non-transitory computer-readable storage medium of claim 21, wherein code for detecting that a branch instruction of the subset of branch instructions is not a fixed direction branch instruction comprises:
code for determining that the branch instruction has been mispredicted at least once as being taken and at least once as being not-taken.

22. The non-transitory computer-readable storage medium of claim 21, further comprising:
code for initializing a prediction state for the branch instruction as always-not-taken, and speculatively executing the branch instruction in a not-taken direction;
code for changing the prediction state for the branch instruction to always-taken, and speculatively executing the branch instruction in a taken direction if, upon speculative execution in the not-taken direction, the branch instruction is determined to be mispredicted; and
code for detecting the branch instruction as belonging to the subset of branch instructions if, upon speculative execution in the taken direction, the branch instruction is determined to be mispredicted.

23. The non-transitory computer-readable storage medium of claim 22, comprising code for associating a counter with the branch instruction, wherein code for initializing the prediction state for the branch instruction as always-not-taken comprises code for initializing the counter to represent a not-taken value;
code for changing the prediction state for the branch instruction to always-taken comprises code for incrementing the counter to represent a taken value; and
code for changing the prediction state for the branch instruction to always taken comprises code for incrementing the counter to a value which represents that the branch instruction belongs to the subset of branch instructions.

24. The non-transitory computer-readable storage medium of claim 20, wherein code for obtaining branch predictions from the neural branch predictor for a branch instruction of the subset of branch instructions comprises:
code for indexing a weight table with a program counter (PC) value of the branch instruction to obtain a bias weight and a weight vector for the branch instruction;
code for determining a partial sum for the branch instruction as a function of the bias weight, the weight vector, and a global history for branch instructions; and
code for determining a branch prediction for the branch instruction based on a sign of the partial sum.

25. An apparatus comprising:
means for detecting a subset of branch instructions which are not fixed direction branch instructions, wherein the fixed direction branch instructions are always-taken or always-not-taken; and
means for obtaining branch predictions from a neural branch predictor, for the subset of branch instructions.

26. The apparatus of claim 25, wherein means for detecting that a branch instruction of the subset of branch instructions is not a fixed direction branch instruction comprises:
means for determining that the branch instruction has been mispredicted at least once as being taken and at least once as being not-taken.

27. The apparatus of claim 26, further comprising:
means for initializing a prediction state for the branch instruction as always-not-taken, and speculatively executing the branch instruction in a not-taken direction;
means for changing the prediction state for the branch instruction to always-taken, and speculatively executing the branch instruction in a taken direction if, upon speculative execution in the not-taken direction, the branch instruction is determined to be mispredicted; and
means for detecting the branch instruction as belonging to the subset of branch instructions if, upon speculative execution in the taken direction, the branch instruction is determined to be mispredicted.

28. The apparatus of claim 27, comprising means for associating a counter with the branch instruction, wherein means for initializing the prediction state for the branch instruction as always-not-taken comprises means for initializing the counter to represent a not-taken value;
means for changing the prediction state for the branch instruction to always-taken comprises means for incrementing the counter to represent a taken value; and
means for changing the prediction state for the branch instruction to always taken comprises means for incrementing the counter to a value which represents that the branch instruction belongs to the subset of branch instructions.

29. The apparatus of claim 28, further comprising means for randomly resetting the counter.

30. The apparatus of claim 25, wherein means for obtaining branch predictions from the neural branch predictor for a branch instruction of the subset of branch instructions comprises:
means for indexing a weight table with a program counter (PC) value of the branch instruction to obtain a bias weight and a weight vector for the branch instruction;
means for determining a partial sum for the branch instruction as a function of the bias weight, the weight vector, and a global history for branch instructions; and
means for determining a branch prediction for the branch instruction based on a sign of the partial sum.
